(19) United States
(12) Patent Application Publication
(10) Pub. No.: US 2023/0103214 A1
(43) Pub. Date: Mar. 30, 2023

(54) MASSAGE SYSTEM

(71) Applicant: AUDI AG, Ingolstadt (DE)

(72) Inventors: Susanne MENTZEL, Ingolstadt (DE); Frank THIERFELDT, Kaiserslautern (DE); Josef MEIER, Kösching (DE); Frank LEWANDOWSKI, Altmannstein (DE); Tobias LANDGRAF, Manching (DE)

(73) Assignee: AUDI AG, Ingolstadt (DE)

(21) Appl. No.: 17/798,148

(22) PCT Filed: Dec. 7, 2020
(86) PCT No.: PCT/EP2020/084784

§ 371 Date: Aug. 8, 2022

(30) Foreign Application Priority Data
Feb. 19, 2020 (DE) 10 2020 104 308.2

(51) Int. Cl. A61H 9/00

(52) U.S. Cl. CPC A61H 9/0078; A61H 2201/1633; A61H 2203/0431; A61H 2201/1207; A61H 2201/1604; A61H 2201/1623; A61H 2205/04; A61H 2205/062

(57) ABSTRACT

A massage system for a seat having a seat surface. At least one plane is defined for the seat, which plane is spanned by a longitudinal axis and a vertical axis of the seat. The at least one plane separates a first side and a second side of the seat from one another and intersects the seat. At least one massage element is arranged in at least one component of the seat. The at least one massage element has at least one active surface which is arranged on at least one of the two sides of the seat. The at least one active surface of the at least one massage element executes at least one stroke movement which is oriented parallel, downwards, and/or upwards at least partially in the direction of the at least one plane, relative to the seat surface

### FIELD

The invention relates to a massage system for a seat and a method for implementing a massage.

### BACKGROUND

A massage assembly can be integrated into a seat of a vehicle, said massage assembly being capable of massaging the back of a person sitting in the seat.

### SUMMARY

Examples of massage assemblies are known from publications DE 10 2011 108 106 B4, KR 20050094008 A, KR 20180089012 A, and CN 101638068 A.

Against this backdrop, an object was to improve a massage for an occupant of a vehicle. This object is achieved by means of a massage system and a method.

The massage system according to the invention is formed and/or provided for a seat having a seat surface, wherein at least one virtual plane, also simply known as at least one plane in the following, is defined, which is spanned and/or defined by a longitudinal axis and a vertical axis of the seat and which extends through the seat. Accordingly, only one such plane can be defined for the seat depending on the embodiment of the massage system. Alternatively, several of such planes can be defined for the seat depending on the embodiment of the massage system. In this case, this at least one plane extends or is arranged through a center of the seat and/or next to the center of the seat, as a so-called plane of symmetry. In this case, this at least one plane intersects the seat and separates the seat into two sides respectively, which are separated from one another by the at least one plane. In this case, at least one massage element is arranged in at least one component of the seat, wherein the at least one massage element has at least one active surface, which is arranged on at least one of the two sides which are separated by the at least one plane, i.e. only on one side and/or on the first side and on the second side of the seat. Thus, the at least one plane can be arranged through the seat symmetrically and/or asymmetrically. The at least one active surface of the at least one massage element is designed to execute at least one stroke movement, which is oriented or aligned parallel or straight, i.e. perpendicular to the vertical axis, downwards and/or upwards, i.e. along or parallel to the vertical axis, and/or outwards, i.e. away from the at least one plane, at least partially in the direction of the at least one plane and/or relative to the seat surface, in order to have contact with a region of a body of a person sitting in the seat and to implement a massage for said region. If the person is sitting in the seat, the at least one stroke movement is oriented and/or aligned essentially in the direction of the region of the body of the person.

In one embodiment of the massage system, at least one row with massage elements is arranged in the at least one component of the seat, wherein a first part of these massage elements or the active surfaces thereof are arranged on the first side and a second part of the massage elements or active surfaces are arranged on the second side of the seat, next to the at least one plane, wherein each massage element is designed to execute a stroke movement which is oriented downwards and/or upwards at least partially in the direction of the at least one plane, wherein the at least one active surface of the at least one massage element is designed to massage the region of the person.

Generally, at least one massage element is designed as a pneumatic massage bubble and/or as an electromechanical massage element.

In one embodiment, at least one massage element or the active surface thereof is oriented downwards or upwards perpendicular as relates to the seat surface of the seat and/or vertical as relates to the seat surface.

The massage elements arranged within the at least one row and/or several active surfaces of massage elements can together form a concave curvature on a surface of the at least one component of the seat. In this case, it is possible that a contact surface for the massage elements is concave, whereby a corresponding directionally dependent effect results in the stroke movements thereof.

The at least one massage element is arranged in a seat component formed as a headrest and/or in a seat component formed as a backrest.

In one embodiment, the massage system has at least one controller, e.g. a control unit, which is pneumatically and/or electrically connected to at least one massage element and is designed to control the stroke movement of the at least one active surface of the at least one massage element in the direction of the at least one plane. In this case, a quantity of air is changed in the at least one massage element designed as a massage bubble. A control unit, which is designed as a pneumatic control unit for example, controls a compressor and valves which are assigned to the massage bubbles. The volumetric flow and pressure generated by the compressor is passed on to the valves via air lines. The airflow is directed from the valves into the massage bubbles via the air lines. For deflation, the airflow is directed out of the massage bubbles through the valves and into the environment. The valves are either open to the environment, wherein a volume and pressure of the air is reduced in the massage bubbles, or closed, wherein the volume and the pressure remain constant. The inflating and deflating of the massage bubbles results in a displacement path and a force according to the stroke movement. The displacement path and the force are transferred to the foam, backing material, and cover of the seat.

In this case, at least one row with pneumatic massage bubbles as the massage elements is arranged in at least one component of the seat, wherein these pneumatic massage bubbles are arranged symmetrically as relates to the at least one plane, wherein a first part of these massage bubbles or the active surfaces thereof is arranged on the first side and a second part of the massage bubbles or the active surfaces thereof is arranged on the second side of the seat, next to the at least one plane, wherein each active surface of each pneumatic massage bubble is designed to execute a stroke movement which is oriented, at an acute angle for example, in the direction of the at least one plane in order to establish contact with a body of a person sitting in the seat in a region and to implement a massage for said region of the body or to massage said region.

Typically, at least one pneumatic massage bubble is oriented perpendicular or downwards or upwards vertically or is tilted as relates to the seat surface.

The pneumatic massage bubbles arranged next one another within the at least one row optionally form or delimit a concave curvature on and/or in a surface of the at least one component of the seat. In one embodiment, active surfaces of several massage elements arranged next to one another can form or delimit a concave curvature.

The pneumatic massage bubbles are arranged, for example, in a seat component formed as a headrest, for example a lower edge of the headrest, and/or are arranged in a seat component designed as a backrest, for example in one side bolster and/or both side bolsters. In this case, at least one massage element can be arranged in at least one side bolster as a component of the seat, wherein the at least one side bolster is designed to execute a movement which is at least partially oriented in the direction of the at least one plane. In this case, a stroke movement of the at least one massage element can be executed simultaneously and/or synchronously to the movement of the at least one side bolster.

The massage system can have at least one pneumatic and/or electric control device, e.g. a control unit and/or a regulating unit, in particular a pneumatic and/or electromechanical control unit, e.g. a pump, which is connected to at least one pneumatic massage bubble via at least one line and is designed to change a quantity of air in the at least one pneumatic massage bubble and thus to control, e.g. initiate, the stroke movement of the at least one pneumatic massage bubble.

The at least one plane, in the direction of which the stroke movement of the at least one active surface of at least one massage element, e.g. the at least one massage bubble, is oriented can be designed as a central plane, e.g. as a plane of symmetry, and/or as a decentralized, laterally offset plane of the seat.

The method according to the invention is provided for massaging a region of the body of a person sitting on a seat surface of a seat, wherein at least one plane, e.g. at least one virtual plane, is defined for the seat, which plane is spanned and/or defined by a longitudinal axis and a vertical axis of the seat. This at least one plane intersects the seat and separates a first side and a second side of the seat, respectfully, from one another. In this case, at least one massage element is arranged in at least one component of the seat, wherein the at least one massage element has at least one active surface which is arranged on at least one side of the at least one plane, e.g. on the first side and/or on the second side of the seat or on a first side and/or a second of the at least one component of the seat, which are likewise separated from one another by the at least one plane. In this case, a stroke movement is executed by the at least one massage element, which stroke movement is oriented or aligned parallel, outwards, downwards, and/or upwards as relates to the seat surface, at least partially in the direction of the at least one plane, wherein the region of the body of the person sitting on the seat surface of the seat has contact with and is massaged with the at least one active surface of the at least one massage element. In this case, several active surfaces of several massage elements can be oriented or are oriented downwards and/or upwards on two different sides of the at least one plane, in the direction of said at least one plane and thus also in the direction of the region of the body of the person. Alternatively or additionally, several active surfaces of several massage elements can be aligned or are aligned parallel or straight, outwards, downwards, and/or upwards relative to the seat surface.

In this case, at least one row with pneumatic massage bubbles as the massage elements is arranged in at least one component of the seat, wherein said pneumatic massage bubbles and the active surfaces thereof are arranged symmetrically and/or asymmetrically as relates to the at least one plane. In this case, a stroke movement is executed by any pneumatic massage bubble and the active surface thereof, which stroke movement is oriented downwards and/or upwards at least partially in the direction of the at least one plane, wherein the region of the body of the person sitting in the seat has contact with and is massaged by the active surface of a respective pneumatic massage bubble due to the stroke movement.

In the embodiment, a region of the person which is formed as the neck, a region of the person which is formed as the shoulder, and/or a region of the person which is formed as the lateral torso is massaged by the at least one active surface of the at least one massage element.

In another embodiment, air is filled, e.g. pumped, into the pneumatic massage bubbles by an electric and/or pneumatic control unit and then suctioned back out of the pneumatic massage bubbles in one possible embodiment. A pressure of the air contained therein can be increased during filling of the massage bubble and then reduced during suctioning in this case. In this case, the same quantity of air can be stored in at least two pneumatic massage bubbles and/or different quantities of air can be stored in at least two pneumatic massage bubbles at a point in time. An electromechanical massage element is actuated and moved by the control unit via an electric signal.

During implementation of the method, a neck massage and/or shoulder massage can be implemented with the massage system for the person sitting in the seat. In addition, a head can be moved, particularly tilted and/or rotated, as the region of the person. The seat and the massage system are provided for a vehicle, e.g. a motor vehicle or an automobile.

Thus, it is possible to expand a massage region for the neck and shoulder region for the person sitting in the vehicle.

The headrest is functionally expanded, among other things, as compared to a known headrest. In addition, the headrest has a cupped shape with a concave surface, for example, due to an orientation of the active surfaces of the massage elements formed, e.g., as massage bubbles in the direction of the at least one plane. In addition, a height adjustment of the headrest is expanded relative to the backrest.

For example, massage bubbles are incorporated into the headrest, on the side bolsters, and in a lateral upper back region as the massage elements with the massage system. Thus, it is possible to implement a direct massage, wherein at least one massage element in the headrest can be used to implement a neck extension and/or nodding movement, wherein at least one massage element in the headrest can be used to implement a rotation of the head of the person, wherein at least one massage element in the headrest can be used to implement an upper shoulder massage or a massage of the upper shoulder. Alternatively or additionally, a massage of the lateral back muscles can also be implemented, wherein at least one massage element can be used in the side bolster and/or in the upper back region of the seat.

By actuating a respective at least one massage bubble which is assigned to a respective body part or region of the body of the person, said body part can be massaged during the method in one embodiment of the massage system.

The at least one massage element, e.g. the at least one pneumatic massage bubble, can have at least one mechanical stroke element, at least one pneumatic cylinder, at least one vibrating element, e.g. a vibration motor or loudspeaker, and or at least one pin which can implement a superposed stroke and rotational movements.

During execution of the method, the shoulder region and/or neck region can be massaged with the massage system as the region of the person. For example, a neck and/or shoulder massage can be transmitted to the seat with the massage system and implemented automatically accordingly by the massage system. Thus, it is possible to expand the massage to regions to the left and right of the spinal column as the regions of the body of the person. The neck can be stretched and/or moved as the region of the body of the person during the method; this is possible, for example, via head movements which are implemented by the at least one active surface of the at least one massage element in the headrest due to the stroke movement. In addition, the massage system can implement a stroking movement on the shoulder during the method. Furthermore, the massage system can massage the lateral torso of the person. Overall, a massage region can be expanded in the vehicle, wherein a higher level of efficiency can be achieved.

Upon implementation of the massage system, the headrest is enlarged and/or expanded, for example in the width and particularly also in the length, wherein a pleasant contact is provided for the neck on the seat. The headrest is expanded, for example, to include a height adjustment.

At least one massage element formed as a massage bubble can be designed as a multi-stroke bubble, e.g. as a three-stroke massage bubble or three-stroke bubble, wherein a multi-stroke bubble has several pneumatic chambers, which are arranged one over the other or under the other as relates to the provided stroke movement.

The at least one massage element for the upper region of the spinal column can be arranged in the headrest. In the embodiment of the method, a gentle, low pressure can be exerted onto a respective region of the body of the person with the at least one massage element. Furthermore, a movement enclosing the region, e.g. the neck, can be executed during the massage. This can mean that several massage elements, e.g. massage bubbles, are focused or aligned on a point of the body of the person from different directions, said elements enclose said point, and then they execute an enclosing movement accordingly which encloses the point or the region.

Foam, e.g. headrest foam or a bolster made from such elastically deformable foam, from which the headrest is formed, is designed, for example, as a cup shape or cavity shape and adapts to a shape of the body, to the shape of the head, among other things. Due to such cupping or cavity, an active or contact surface of at least one massage element, normally of several massage elements, is set and/or oriented at an acute angle of, e.g., about 10° in the direction of the person or the occupant. The acute angle, about which the active or contact surface of the at least one massage bubble is oriented in the direction of the person, can vary in embodiment from an acute angle, e.g., of about 5°-20°.

In addition, at least two chambers, arranged below on the headrest, of a massage bubble, which is formed as a multi-stroke bubble, e.g. as a three-stroke bubble, can be welded together on the inside via a strip, e.g. a film strip.

A concealed, possibly indirect prong fastener can be attached to the seat between the at least two massage bubbles so that the massage bubbles enclose, for example, the neck. A strip, formed e.g. as a pull strap, can be sewn to an under-stitched flexible and/or elastically deformable cover of the headrest, e.g. to a stretch cover. In this case, an anchor or a tilt profile for the pull strap can be threaded, tilted, folded over, and/or positioned through the foam and onto a headbox of the headrest.

Furthermore, a movement upwards can be executed by the massage element, wherein the neck is slightly stretched.

At least one massage bubble can be embodied or characterized as a stroke bubble with several pneumatic chambers. Several pneumatic chambers can be welded to an inside of the at least one massage bubble by at least one strip, e.g. film strip or pull strap. In the event that several, e.g. three, chambers are arranged within the concave-shaped surface of the seat, e.g. within a cavity or curvature of the seat, these chambers can likewise be connected to the inside of the concave-shaped surface, e.g. welded thereto, via the at least one strip. The three chambers, for example, can rest on a curved surface or plane and can execute a stroke movement in the direction of the at least one plane. With the operation of the massage system within the scope of the method, different movements, e.g. rotations, are implemented by the massage elements, in addition to the longitudinal stroke movements, for example. In this case, different variants are possible for rotations, e.g. for rotations of chambers of a massage bubble.

In the embodiment, at least one massage bubble can be formed or characterized as a double-fold bubble.

An overflow element for at least one massage bubble can be arranged off-center, in the direction of an edge of the component of the seat, or placed inwards, upwards, or/or downwards in the direction of the at least one plane. The stroke movement forwards can be superposed with a rotational movement outwards, inwards, upwards, or downwards. Furthermore, several massage bubbles can be connected directly to one another optionally using weld seams. In addition, several chambers of a massage bubble can be connected to one another via weld seams in the chambers.

It is possible to replace two individual massage bubbles, which are arranged next to one another, e.g. directly next to one another, with one massage bubble which has two chambers and an overflow element. It is possible for two massage bubbles and/or chambers of a massage bubble to be connected to one another via a tube.

Several massage elements can be attached or arranged in an upper region of the headrest, on or underneath a foam, e.g. on the A side or B side. In this case, a massage element arranged on the A side is facing a surface of the seat and a massage element arranged on the B side is facing away from the surface.

These massage elements can move or tilt the head forwards, e.g. in the vertical direction.

One massage element each can be arranged on the left and right on or under the foam, e.g. the molded foam or a seat bolster made of foam, in the same region of the headrest. These massage elements can rotate the head to the right and left, e.g. in the horizontal direction. The head does not receive any pressure point massage in this case as with a back massage; instead, the head is passively moved by the massage elements.

It is further possible that massage elements, e.g. massage bubbles, are attached or arranged on the lower edge or a lower edge of the headrest. During operation of the massage system, first the inner and then the outer massage bubbles or, vice versa, first the outer and then the inner massage bubbles are filled with air. Thus, the massage bubbles execute a stretching movement in the upper, rear region of the shoulder of the person. So that this region of the shoulder is reached, the active surface or the contact surface of the massage elements is tilted, i.e. the active surfaces of the inner massage elements are tilted, in one embodiment, about a first acute angle of 23°, for example, and the active surfaces of the outer massage elements are tilted about a larger, second acute angle of 34°, for example, in the direction of the at least one plane of the seat, wherein massage elements are oriented, e.g. tilted, e.g. at a torso angle, toward a torso or body of the person, according to this angle respectively.

In one embodiment, a respective angle, e.g. tilt angle, of an active surface of a respective massage bubble can vary, e.g. between 0° and 45°, from inside to outside, wherein an active surface of a massage element, which is arranged further out in the region of a concave-curved surface of the headrest, i.e. further away from the at least one plane, e.g. at the edge of this region, is tilted by a greater angle than an active surface of a massage element arranged further in as relates to the body of the person, with less distance away from the at least one plane.

Furthermore, at least one massage bubble can be designed as a multi-stroke bubble, e.g. a four-stroke, five-stroke, or six-stroke bubble, which has several pneumatic chambers. In this case, a guide required by the at least one multi-stroke bubble may be arranged for the guide chambers for at least one multi-stroke bubble, e.g. for several multi-stroke bubbles, on the seat, e.g. on the headrest, wherein the individual chambers of the multi-stroke bubble are arranged stably above one another and moved in the direction of the stroke movement.

A stroke or a bubble stroke or a length by which the stroke bubble is moved relative to the surface of the seat, e.g. the headrest, during execution of the, e.g. longitudinal, stroke movement, has a maximum value. The durability of the massage bubble can be ensured by limiting the stroke. A cover or headrest cover of the headrest can be at least partially formed from flexible and/or elastically deformable material, e.g. stretch material. At least one massage bubble can be attached to the headrest via a two-sided film strip. A rubber strip or stretch material can be arranged, e.g. wound, about at least one massage bubble.

Different materials, particularly flexible and/or elastically deformable materials, can be provided for the massage bubbles, generally for shells of chambers of the massage bubbles. In this case, a respective shell encloses an interior of a respective chamber of a massage bubble. During operation of the massage system, a quantity of air within the interior of the chamber of the respective massage bubble, which is enclosed by the elastic shell, for example, is changed, e.g. in a rhythmic, periodic, oscillating, and/or cyclic manner, i.e. enlarged or reduced, wherein a volume of the at least one massage bubble is accordingly changed in a rhythmic, periodic, oscillating, and/or cyclic manner. The at least one massage bubble and/or chamber or shell thereof can be formed from very elastic material, e.g. an elastomer, similar to an air balloon. The at least one massage bubble and/or chamber can also be formed, for example, as bellows, which are formed, for example, from a thermoplastic material, e.g. from polypropylene (PP), wherein the length or stroke thereof is extended in the manner of an accordion when the air is under higher pressure and shortened when the air is under less pressure. The at least one massage bubble can also be arranged in a seat back or backrest and/or headrest of the seat. The massage bubbles can be produced, for example, from a punched film material. In this case, several sections of this film material can be connected, e.g. welded, to a massage bubble.

In one embodiment of the method or during operation of the massage system and thus during a cycle of the massage, the chambers of the massage bubbles are filled with air individually, wherein many different quantities of air are in the chambers of various massage bubbles at a point in time, wherein the massage bubbles are raised and/or expanded to different degrees. It is conceivable in this case that initially massage bubbles on a left side of the at least one component of the seat are filled with air and subsequently those on the right side of the at least one component of the seat are filled with air or vice versa. Due to the, e.g. dynamic, changing of a quantity of air in the chambers of the massage bubbles, a surface of the seat that has contact with the body of the person is changed, at least in sections, wherein a shape of the surface can be changed, for example in a wave-like, cyclic, rhythmic, and/or oscillating manner, depending on how much air is currently in a respective massage bubble. It is also possible to fill several, for example all, massage bubbles with air simultaneously, for example at a point in time, or to suction the air back out.

In one embodiment, massage elements can be arranged or positioned on a side bolster and/or in a lateral upper back region of the backrest of the seat. Massage points on the lateral torso of the person are then reached with these massage elements. In one variant, the massage elements may also be integrated into a backrest bolster adjustment and/or side bolster adjustment of the seat, wherein a better massage effect can be achieved for a slender person or slender occupant. In one embodiment, it is possible that the backrest bolsters and/or side bolsters of the seat move inwards, e.g. alternate between oscillating inwards and outwards with one embodiment of the method, in the direction of the at least one plane and thus in the direction of the person sitting in the seat, wherein a stroke movement of massage elements in the backrest bolsters and/or side bolsters is executed synchronously with the movements of the backrest bolsters and/or side bolsters.

In addition, a neck heater or neck warmer can be integrated into the headrest as a further component of the massage system.

In one embodiment of the massage system, all massage bubbles can be formed, for example, as three-stroke bubbles with three chambers and used for all massages. The massage bubbles can be varied with respect to the shape thereof and designed correspondingly differently. Thus, at least one massage bubble, typically the active surface thereof, can be designed in a round, oval, angular, e.g. in a rectangular or squared, shape. Accordingly, various massage bubbles or the active surfaces thereof which are integrated into the seat can have different shapes and be of different sizes, wherein at least a few massage bubbles are smaller and others larger. Several massage bubbles and/or chambers of a respective massage bubble can be attached to one another at a weld seam, for example a cambered weld seam or corrugated weld seam. In addition, the at least one massage bubble can be positioned on a B side or A side of the foam and/or of the bolster of the seat, wherein the at least one massage bubble can be arranged on a backside of the foam which is facing away from the person sitting in the seat or on a front side of the foam which is facing the person.

Several massage elements can be arranged differently, for example along a row or a line, next to one another and/or behind one another, particularly directly adjacent or bordering one another, or arranged in a circle shape or radially. Two directly adjacent massage elements can be spaced apart from one another, wherein a space or a gap is located between said massage elements. Several rows of massage elements can be arranged perpendicular to the at least one plane or horizontally, wherein massage elements from various horizontal rows are arranged above one another or below one another.

In one embodiment of the method, massage bubbles are filled with air individually or in pairs; it is also possible for all massage bubbles to be filled with air. A sequence according to which the massage bubbles are filled with air can vary with a respective embodiment of the method.

The at least one massage element can be attached to the seat in different ways. In this case, the at least one massage element can be inserted, bonded, and/or welded onto a film strip, particularly by piercing the film strip. For the attachment thereof, the at least one massage element can be bonded to and/or on the seat, welded thereon, and/or clipped therewith, and/or inserted thereon.

The least one massage bubble is formed pneumatically and, in one embodiment, can have at least one mechanical element as well, particularly a stroke element, e.g. a motor and/or a gear, at least one pneumatic cylinder, at least one vibration motor, at least one motor with imbalance, and/or at least one loudspeaker, for example to excite the air in the at least one massage bubble, and/or can interact with or be connected to such a mechanical element, wherein, in one embodiment of the method, a vibration massage can be implemented with the vibration motor and/or the loudspeaker, which vibration massage can be superposed with at least one stroke movement. In addition, the at least one massage bubble can have at least one finger, i.e. a pin with a rounded end, as a mechanical element. In the method, each massage bubble is actuated, for example by a control unit of the massage system, and is moved, normally by changing the quantity of air in a respective massage bubble. In this case, each massage bubble is connected to the control unit via at least one line, wherein the at least one mechanical, electrical, electromechanical, and/or pneumatic element, e.g. massage element, can also be connected to the control unit. All massage bubbles can execute different movements.

The at least one massage element can be arranged in the headrest or also in the seat back, e.g. backrest, of the seat. A massage direction and thus the direction of a stroke movement of the at least one massage element can be oriented at an acute angle of less than 90° or vertically or at an angle of 90° as relates to the at least one plane, the headrest, and/or the seat back. Among other things, a direct massage, shoulder massage, and/or head massage can be implemented with the at least one, for example pneumatic, massage element that is arranged, for example, in the headrest.

In one embodiment of the method with an embodiment of the massage system, different massage regions and/or massage points and thus regions or points on the body of the person can be massaged. Therefore, the upper neck and/or shoulder musculature can be massaged, for example due to a stretching movement of the massage elements outwards. In addition, a stretching of an upper neck region can be implemented, for example due to a tilting movement and/or rotational movement of the massage elements. Furthermore, the upper back of the person can be massaged by the massage elements. In addition, a massage of the lateral back muscles and shoulder muscles is possible.

### BRIEF DESCRIPTION OF THE FIGURES

The invention is schematically shown in the drawings by means of embodiments and is described schematically and extensively with reference to the drawings.

FIG. 1 shows a schematic view of a first embodiment of the massage system according to the invention for a seat.

FIG. 2 shows a schematic view of details of a second embodiment of the massage system according to the invention for a seat.

FIG. 3 shows a schematic view of details of a first variant of the first embodiment of the massage system according to the invention from FIG. 1.

FIG. 4 shows a schematic view of further details of the first embodiment of the massage system according to the invention embodiment from FIG. 1.

FIG. 5 shows a schematic view of a massage bubble of a further embodiment of the massage system according to the invention.

FIG. 6 shows a schematic view of further examples of massage bubbles.

The figures are cohesively and comprehensively described; equivalent components have been assigned the same reference numerals.

### DETAILED DESCRIPTION

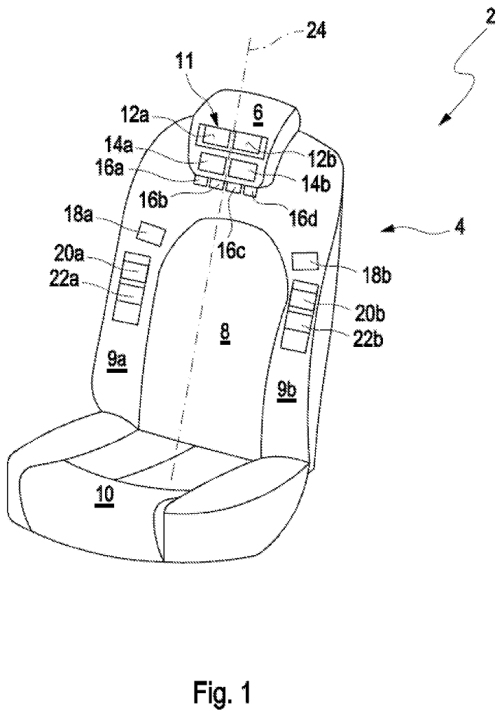

The first embodiment of the massage system 2 according to the invention schematically shown in FIG. 1 is formed or provided for a seat 4 of a vehicle, which is a motor vehicle or an automobile here. The components of the seat 4 include a headrest 6 for a head of a person sitting in the seat, a backrest 8 for the back of the person, and a seat cushion 10 as a seat surface for the buttocks of a person. The backrest has two side bolsters 9a, 9b in this case. In addition, a plane 24, which is a plane of symmetry here, of the seat 4 is indicated by a line, which plane is spanned by a horizontally oriented longitudinal axis of the seat 4 and a vertically oriented vertical axis of the seat 4 and which separates the seat 4 into two sides which are separated from one another by the plane 24.

The massage system 2 has several massage bubbles 11, 12a, 12b, 14a, 14b, 16a, 16b, 16c, 16d, 18a, 18b, 20a, 20b, 22a, 22b as massage elements, which are integrated into the headrest 6 and the backrest 8 as components of the seat 4 in this case, wherein the headrest 6 and the backrest 8 can also be formed as components of the massage system 2 depending on the definition.

In contrast to known headrests, it is provided in this case that the headrest 6 is extended downwards by several centimeters, e.g. by about 63 mm, parallel to the plane 24 and is expanded in a lower region.

The massage system 2 has a first massage bubble 11 and two further massage bubbles 12a, 12b, wherein the two further massage bubbles 12a, 12b are integrated into the headrest 6 horizontally next to one another along a first uppermost row, wherein these two further massage bubbles 12a, 12b are arranged symmetrically as relates to the plane 24, with a first further massage bubble to the left on the first side of the seat 4 and a second massage bubble 12b on the second side of the seat 4. The first massage bubble 11 is elongated and arranged underneath the two second massage bubbles 12a, 12b as relates to the surface of the seat 4 wherein the first massage bubble 11 forms a first layer and the second massage bubbles 12a, 12b arranged above form a second layer. In this case, the first massage bubble 11 can be arranged on the foam of a B side of the seat 4. Foam can likewise be arranged between the first massage bubble 11 and the two second massage bubbles 12a, 12b. Each massage bubble 11, 12a, 12b has at least one active surface. In this case, the first massage bubble 11 is formed to nod and/or to stretch and/or to expand the head of the person. The second massage bubbles 12a, 12b are formed to rotate the head.

A pair of massage bubbles 14a, 14b is integrated into the headrest 6 horizontally next to one another along a second row, under the first massage bubble 11 or the active surfaces 12a, 12b thereof, wherein these two massage bubbles 14a, 14b are arranged symmetrically as relates to the plane 24, with one massage bubble 14a, 14b on the left side of the seat 4 and the other on the right side of the seat 4, wherein each massage bubble 14a, 14b has an active surface here.

A third row with a total of four massage bubbles 16a, 16b, 16c, 16d arranged horizontally next to one another, each with an active surface, is integrated into a lower edge of the headrest 6 here. These massage bubbles 16a, 16b, 16c, 16d or the active surfaces thereof are likewise arranged symmetrically as relates to the plane 24, with two massage bubbles 16a, 16b on the left side of the seat 4 and the two other massage bubbles 16c, 16d on the right side of the seat 4 of the plane 24. Furthermore, these massage bubbles 16a, 16b, 16c, 16d are oriented diagonally downwards and/or tilted in the lower edge of the headrest 6, starting from the headrest 6.

Two massage bubbles 18a, 18b, each with an active surface symmetrical as relates to the plane 24, are integrated into the two side bolsters 9a, 9b of the backrest 8 in a fourth row, namely a first massage bubble 18a in a first side bolster 9a of the seat 4 on the left or right depending on perspective and a second massage bubble 18b in a second side bolster 9b of the seat 4 on the left or right depending on perspective. A fifth row has two massage bubbles 20a, 20b integrated into the two side bolsters 9a, 9b of the backrest 8 symmetrical as relates to the plane 24, namely a first massage bubble 20a in the first side bolster 9a and a second massage bubble 2b in the second side bolster 9b. In addition, a sixth bottommost row has two massage bubbles 22a, 22b integrated into the two side bolsters 9a, 9b of the backrest 8 symmetrical as relates to the plane 24, namely a first massage bubble 22a in the first side bolster 9a and a second massage bubble 22b in the second side bolster 9b. Accordingly, three massage bubbles 18a, 20a, 22a are arranged in the first side bolster 9a and three massage bubbles 18b, 20, 22b are arranged in the second side bolster 9b, above or below one another. Alternatively, the massage bubbles 18a, 18b can also be arranged above the side bolsters 9a, 9b.

A first embodiment of the method presented for implementing a massage of the person sitting in the seat 4 can be implemented with the massage system 2 presented. In this case, a stretching of the neck and/or a nodding movement of the head of the person and a rotation of the head of the person are implemented along the first uppermost row with the active surfaces of the massage bubbles 11, 12a, 12b. A direct massage of the neck of the person is implemented with the two massage bubbles 14a, 14b or the active surfaces thereof along the second row. In this case, a slight stretching of the neck of the person is possible due to a positioning or orientation of the massage bubbles 14a, 14b diagonally upwards. A massage of the upper shoulder of the person is implemented with the four massage bubbles 16a, 16b, 16c, 16d or the active surfaces thereof in the third row, wherein a movement oriented vertically downwards is implemented by the massage bubbles 16a, 16b, 16c, 16d along the plane 24 in the direction of a seat surface. A massage is implemented for lateral regions of the back or one respective lateral region of the back with the massage bubbles 18a, 18b, 20a, 20b, 22a, 22b or the active surfaces thereof in the side bolsters 9a, 9b.

In addition, the side bolsters 9a, 9b and thus also the massage bubbles 18a, 18b, 20a, 20b, 22a, 22b integrated therein are moved, e.g. adjusted and/or pivoted, relative to the plane 24 with respect to the position thereof. In this case, it is possible that the side bolsters 9a, 9b and thus the massage bubbles 18a, 18b, 20a, 20b, 22a, 22b are pivoted respectively to a position provided for this purpose in order to implement and/or prepare the massage, wherein a width of the backrest 8 is adapted to the size of the person sitting in the seat 4 who is to be massaged. Alternatively or additionally, the side bolsters 9a, 9b and thus the massage bubbles 18a, 18b, 20a, 20b, 22a, 22b can also be moved typically back-and-forth relative to the plane 24 during the massage. It is conceivable here that the massage bubbles 18a, 18b, 20a, 20b, 22a, 22b execute the stroke movements thereof simultaneously or synchronously to the movements of the side bolsters 9a, 9b.

In addition, it is provided here that the massage bubbles 11, 14a, 14b, 16a, 16b, 16c, 16d, 18a, 18b, 20a, 20b, 22a, 22b or the active surfaces 12a, 12b thereof are integrated into a foam or a bolster of the respective component of the seat 4 here and are covered by a cover of the respective components of the seat 4 or arranged underneath.

Each massage bubble 11, 14a, 14b, 16a, 16b, 16c, 16d, 18a, 18b, 20a, 20b, 22a, 22b has a deformable shell as the massage element in one embodiment, into which shell air is filled, wherein, during the method, a quantity of air within a respective massage bubble 11, 14a, 14b, 16a, 16b, 16c, 16d, 18a, 18b, 20a, 20b, 22a, 22b is varied and/or changed, whereby a respective volume which is enclosed by the shell of the respective massage bubble 11, 14a, 14b, 16a, 16b, 16c, 16d, 18a, 18b, 20a, 20b, 22a, 22b is varied and/or changed. In this case, a vertical or tilted stroke movement is executed by the respective massage bubble 11, 14a, 14b, 16a, 16b, 16c, 16d, 18a, 18b, 20a, 20b, 22a, 22b as relates to a surface of the respective component of the seat 4, i.e. the headrest 6 or the backrest 8, wherein a height or expansion of the respective massage bubble 11, 14a, 14b, 16a, 16b, 16c, 16d, 18a, 18b, 20a, 20b, 22a, 22b is moved dynamically and changed relative to the surface of the component of the seat 4, e.g. the headrest 6 or the backrest 8.

To this end, at least one massage bubble 11, 14a, 14b, 16a, 16b, 16c, 16d, 18a, 18b, 20a, 20b, 22a, 22b can be connected to a power unit, e.g. a pump, as a control unit via at least one air line, e.g. via at least one tube, to control, i.e. to change, the quantity of air in the at least one massage bubble 11, 14a, 14b, 16a, 16b, 16c, 16d, 18a, 18b, 20a, 20b, 22a, 22b, wherein air is conveyed or filled by the pump into the at least one massage bubble 11, 14a, 14b, 16a, 16b, 16c, 16d, 18a, 18b, 20a, 20b, 22a, 22b, wherein the air can be directed out. In one possible embodiment, air can be suctioned or extracted from the at least one massage bubble 11, 14a, 14b, 16a, 16b, 16c, 16d, 18a, 18b, 20a, 20b, 22a, 22b. Furthermore, at least one controllable valve can be arranged along the at least one air line, between the power unit and the at least one massage bubble 11, 14a, 14b, 16a, 16b, 16c, 16d, 18a, 18b, 20a, 20b, 22a, 22b. If the at least one valve is open, it is possible to change the quantity of air in the at least one massage bubble 11, 14a, 14b, 16a, 16b, 16c, 16d, 18a, 18b, 20a, 20b, 22a, 22b via the pump. If the at least one valve is closed, it is possible to keep the quantity of air in the at least one massage bubble 11, 14a, 14b, 16a, 16b, 16c, 16d, 18a, 18b, 20a, 20b, 22a, 22b constant. In this case, air can be directed into the environment depending on a position of the at least one valve, wherein pressure equalization is possible. If a respective valve is open, a massage bubble assigned thereto will be ventilated.

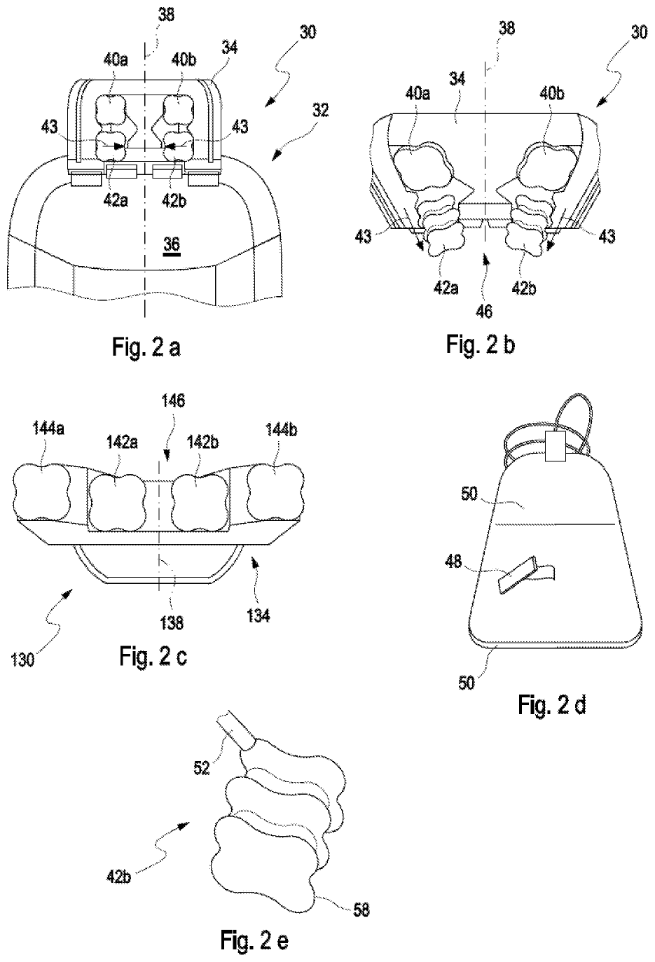

The second embodiment of the massage system 30 according to the invention, which is shown schematically in a plan view in FIG. 2a, is formed or provided for a seat 32 of a vehicle, for example a motor vehicle in this case, of which, in FIG. 2a, a headrest 34 and a backrest 36, each without a cover or covering, are suitable as the components. In this case, a plane 38, e.g. a plane of symmetry, of the seat 32 is indicated by a line. This plane 38 divides the seat 32 into two sides or separates the two sides of the seat 32 from one another.

The massage system 30 has several massage bubbles 40a, 40b, 42a, 42b, which are integrated into the headrest 34 here, and which likewise can be formed or characterized as a component of the massage system 30.

In this case, a first pair of massage bubbles 40a, 40b, each with a respective active surface, are integrated into the headrest 34 horizontally next to one another along a first uppermost row, wherein these two massage bubbles 40a, 40b are arranged symmetrically as relates to plane 38 or to the left and right of plane 24 or on the left side and right side of the seat 4.

A second pair of massage bubbles 42a, 42b, each with a respective active surface, is integrated into the headrest 34 horizontally next to each other along the first uppermost row, wherein these two massage bubbles 42a, 42b are also arranged symmetrically as relates to plane 38 or on both sides of seat 32, symmetrically as relates to the plane 38.

These two massage bubbles 42a, 42b are also shown from above in FIG. 2b.

FIG. 2c shows a further variant of the massage system 130 for a headrest 134 of a seat for a vehicle in a schematic sectional view through the headrest 134, wherein two inner massage bubbles 142a, 142b and two outer massage bubbles 144a, 144b are arranged symmetrically as relates to plane 138 of the seat. FIG. 2c also shows that the inner massage bubbles 142a, 142b are arranged between the outer massage bubbles 144a, 144b in this case.

With the massage system 30, active surfaces of the two respective massage bubbles 42a, 42b are oriented at an acute angle of about 10° in the direction of the plane 38, whereby they form a concave cavity 46 or cupping or curvature for a surface for the headrest 34.

In addition, with one variant of the massage system 130, active surfaces of the two respective massage bubbles 142a, 142b are both oriented downwards at an acute angle of about 10°, whereby they form a concave cavity 146 or cupping or curvature for a surface for the headrest 134.

FIG. 2d shows a pull strap 48 with an anchor and a cover 50 made of elastic or flexible material. A concealed prong fastener, not shown in further detail, is attached between the massage bubbles 42a, 42b, 142a, 142b of both variants so that the massage bubbles 42a, 42b, 142a, 142b or the active surfaces thereof enclose the neck of a person sitting in the seat 32 or the shoulders of the person diagonally. The pull strap 48 is sewn onto the under-stitched cover or stretch covering for the headrest 34, 134 and the anchor is threaded through the foam bolsters into a headbox of the headrest 34, 134. A rod is arranged in the headbox, with which rod the headrest 34, 134 can be moved relative to a backrest.

FIG. 2e shows the massage bubble 42b enlarged and a tube 52 assigned thereto. The massage bubble 42b schematically shown in FIG. 2e is formed as a three-stroke bubble here, which has three chambers arranged over one another. FIG. 2e also shows an edge 58 of an uppermost chamber of said massage bubble 42b formed as a three-stroke bubble, wherein this edge 58 encloses the active surface of the massage bubble 42b.

In this case, it is provided that a height of the headrest 6, 34, 134 can be adjusted relative to the backrest 8, 36, wherein a vertical position of the massage bubbles 11, 12a, 12b, 42a, 42b, 142a, 142b, 144a, 144b or the active surface thereof can be adapted to a position of the neck of the person. The massage bubbles 11, 12a, 12b, 42a, 42b, 142a, 142b, 144a, 144b or the active surfaces thereof form the concave cavity 46, 146 and enclose a neck of a person sitting in the seat 32 due to the tilted arrangement and/or orientation thereof relative to the plane 38, 138.

The respectively presented massage system 2, 30, 130 can realize a respective embodiment of the presented method for implementing a massage of the neck or the upper region of the spinal column of the person sitting in the seat 2, 32 and the massage bubbles 11, 12a, 12b, 42a, 42b, 142a, 142b, 144a, 144b can have contact with the headrest 6, 34, 134.

In one embodiment, each massage bubble 11, 12a, 12b, 42a, 42b, 142a, 142b, 144a, 144b has an elastically deformable shell with at least one chamber into which air is filled, wherein a quantity of air within the at least one chamber of a respective massage bubble 11, 12a, 12b, 42a, 42b, 142a, 142b, 144a, 144b is varied and a respective volume which is enclosed by the shell of the respective massage bubble 11, 12a, 12b, 42a, 42b, 142a, 142b, 144a, 144b is changed during the method. In this case, a cyclical and/or oscillating stroke movement is implemented by the respective massage bubble 11, 12a, 12b, 42a, 42b, 142a, 142b, 144a, 144b or the active surface thereof relative to a surface of the headrest 34, 134 in the direction of the neck of the person, wherein a height or expansion of the respective massage bubble 11, 12a, 12b, 42a, 42b, 142a, 142b, 144a, 144b is moved, e.g. dynamically, relative to the neck. This stroke movement is indicated by arrow 43 in the example of massage bubbles 42a, 42b in FIGS. 2a and 2b.

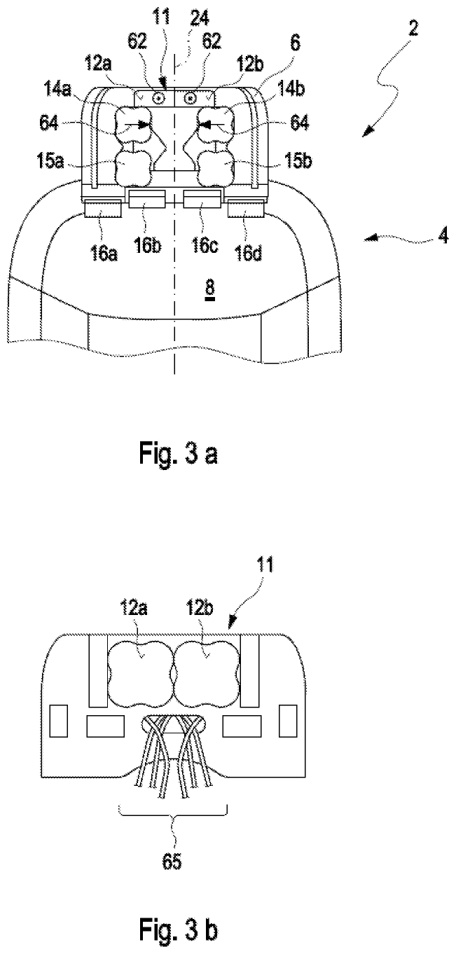

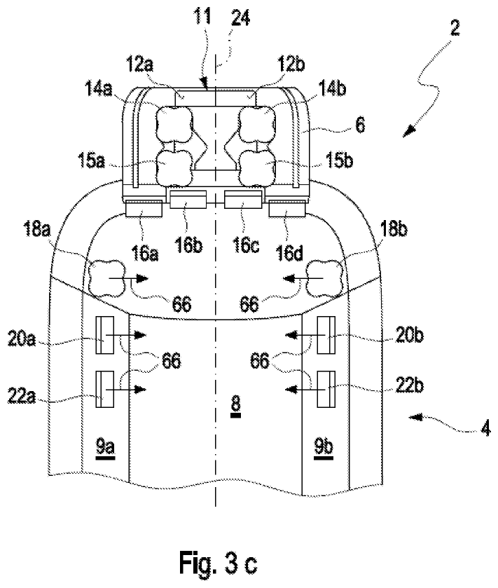

FIG. 3a shows a schematic representation of the headrest 6 and the backrest 8 of the variant of the first embodiment of the massage system 2 for the seat 4 from FIG. 1 without a cover. In addition to the massage bubbles 11, 14a, 14b, 16a, 16b, 16c, 16d or the active surfaces thereof already indicated by means of FIG. 1, FIG. 3a shows two additional massage bubbles 15a, 15b, each with an active surface, which are arranged between the second row of massage bubbles 14a, 14b and the third row of massage bubbles 16a, 16b, wherein these two additional massage bubbles 15a, 15b or the active surfaces thereof are likewise arranged symmetrically as relates to the plane 24, on the two sides of the seat 4 separated by the plane 24.

The two active surfaces 12a, 12b of the uppermost massage bubble 11 are also schematically shown in FIG. 3b. This massage bubble 11 comprises two chambers arranged next to one another, wherein each chamber has an active surface 12a, 12b, wherein these two active surfaces 12a, 12b can also form a common active surface, depending on the definition. The two active surfaces 12a, 12b here are connected, via pneumatic lines 65, to at least one electric and/or pneumatic control unit, not shown in greater detail here, which has a power unit, e.g. a pump, which is formed to convey air to the at least one chamber and the assigned active surface 12a, 12b of the massage bubble 11 through an, e.g. pneumatic, line 65.

Due to an exchange of air between the pump and the chambers of the massage bubble 11, a stroke movement, which is indicated by dotted circles 62 in FIG. 3a, is executed by the active surfaces 12a, 12b, starting from the chambers, in one embodiment of the method. These active surfaces 12a, 12b of the massage bubble 11 are arranged underneath the foam of bolsters of the headrest 6 in the upper region of the headrest 6 and, with one embodiment of the method, are formed to move and/or to tilt the head of the person sitting in the seat 4 forward due to the stroke movement (dotted circles 62).

Accordingly, the massage bubbles 14a, 14b are also connected, via electric and/or pneumatic lines, to at least one electric and/or pneumatic control unit, e.g. to a pump, which is formed to convey air into the massage bubbles 14a, 14b and, in one potential embodiment, also to extract it, wherein a stroke movement, which is indicated by arrow 64 in FIG. 3a, is executed by the active surfaces of the massage bubbles 14a, 14b in the direction of the plane 24, with the embodiment of the method. The massage bubbles 14a, 14b, 15a, 15b in this case are arranged to the left and right of the plane 24, on molded foam of the headrest 6, and are formed to rotate the head of the person to the right and to the left as relates to the plane 24, indicated by arrow 64.

FIG. 3c is based on FIGS. 1 and 3a, wherein the massage bubbles 18a, 18b, 20a, 20b, 22a, 22b are also shown schematically in the side bolsters 9a, 9b of the backrest 8 without a cover. In the embodiment of the method, the massage bubbles 18a, 18b, 20a, 20b, 22a, 22b or the active surfaces thereof also execute stroke movements, indicated here by arrow 66, and are oriented in the direction of the plane 24 and thus also in the direction of a lateral torso or upper body of the person sitting in the seat 4.

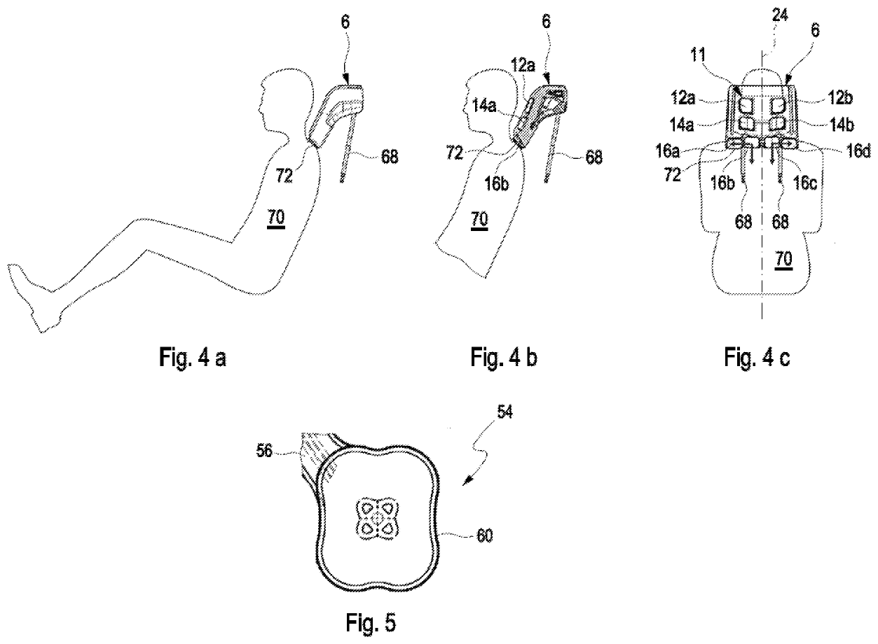

The headrest 6 of the seat 4 and the embodiment of the massage system 2 are schematically shown from the side in FIG. 4a, from the side in FIG. 4b in a section, and from the front in a plan view in FIG. 4c. This shows that the two chambers or the active surfaces 12a, 12b of the massage bubble 11 assigned to the chambers are arranged symmetrically as relates to the plane 24. In this case, FIGS. 4a, 4b, 4c also show two rods 68, via which the headrest 6, i.e. a headbox of the headrest 6, is connected to the backrest 8, which is not shown here, and can be displaced extensively vertically as relates to the backrest 8. In addition, FIGS. 4a, 4b, 4c also show a person 70 sitting in the seat 4.

The third row with the four massage bubbles 16a, 16b, 16c, 16d arranged horizontally next to one another is integrated into the lower edge 72 of the headrest 6 here, wherein the lower edge 72 and the massage bubbles 16a, 16b, 16c, 16d are oriented and/or tilted downwards diagonally, wherein the two inner massage bubbles 16b, 16c here are tilted downwards at a first angle of about 34°, for example, and the two outer massage bubbles 16a, 16d here are tilted downwards at a second angle of about 26°, for example, and thus in the direction of the neck and/or the shoulder of the person 70 as the region. Typically, the first angle is greater than the second angle which means that an inner massage bubble 16b, 16c is tilted downwards at a greater angle than an outer massage bubble 16a, 16b. Alternatively, it is conceivable that an outer massage bubble 16a, 16d is tilted downwards as an inner massage bubble 16b, 16c. In this case, the person 70 can rest their shoulder and/or their upper back against the lower edge 72, depending on the definition and/or posture of the person 70, wherein the massage bubbles 16a, 16b, 16c, 16d form a contact surface tilted downwards and curved concavely and have contact with the shoulder and/or upper back, particularly partially enclose the neck.

In one embodiment of the method, the massage bubbles 16a, 16b, 16c, 16d are filled with air in the lower edge 72 and a quantity of the air changes, wherein a stroke movement, which is oriented in the direction of the shoulder and/or the upper back of the person 70, is executed by each massage bubble 16a, 16b, 16c, 16d. The arrows here represent a potential movement sequence. Thus, the inner massage bubbles 16b, 16c are filled with air and moved downwards. Furthermore, the inner massage bubbles 16b, 16c are ventilated and the outer massage bubbles 16a, 16d are filled with air simultaneously. Furthermore, a stroke movement can be executed in the horizontal or vertical direction also by any inner massage bubble 16b, 16c, and a stroke movement can also be executed in the horizontal or vertical direction by any outer massage bubble 16b, 16c. Since a quantity of air is varied in the massage bubbles 16a, 16b, 16c, 16d, the stroke movement of a respective massage bubble 16a, 16b, 16c, 16d in a respective direction changes. In this case, is provided in one embodiment of the method that initially the inner massage bubbles 16b, 16c and subsequently the outer massage bubbles 16b, 16c are filled with air.

FIG. 5 shows another variant of a massage bubble 54 as a massage element of a further embodiment of the massage system with an assigned overflow element 56. In this case, an active surface of this massage bubble 54 is enclosed by an edge 60. Such an overflow element 56 is formed as a guide and/or line for air as an alternative to a tube. Furthermore, the overflow element is an extension of the massage bubble 54 or the geometry thereof and is produced from two films welded together, just as the massage bubble 54.

An outer edge 58, 60 of the surface of the respective massage bubble 42b from FIG. 2e and the massage bubble 54 from FIG. 5 resembles a periodic function, e.g. R_{b,c} (α)=c−b*cos (4*α). This function R_{b,c} (α) describes a distance between the edge 58, 60 and a center point of the surface of the massage bubble 42b, 54, wherein α is an angle between 0° and 360°, b is an amplitude of the cosine function, and c is a constant, where c>b. In the embodiment, c can be at least twice, e.g. n-times, as big as b. A minimum distance between the edge 58, 60 and the center point of the surface with the value c−b results respectively at α=0°, 90°, 180°, 270°, and 360°. A maximum distance between the edge 58, 60 and the center point with the value c+b results respectively at α=45°, 135°, 225°, and 315°.

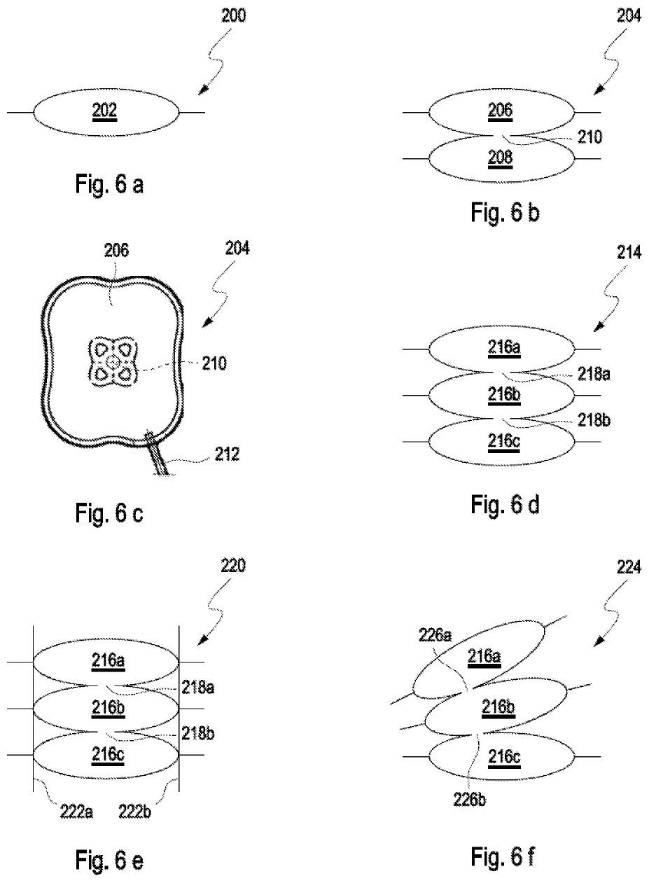

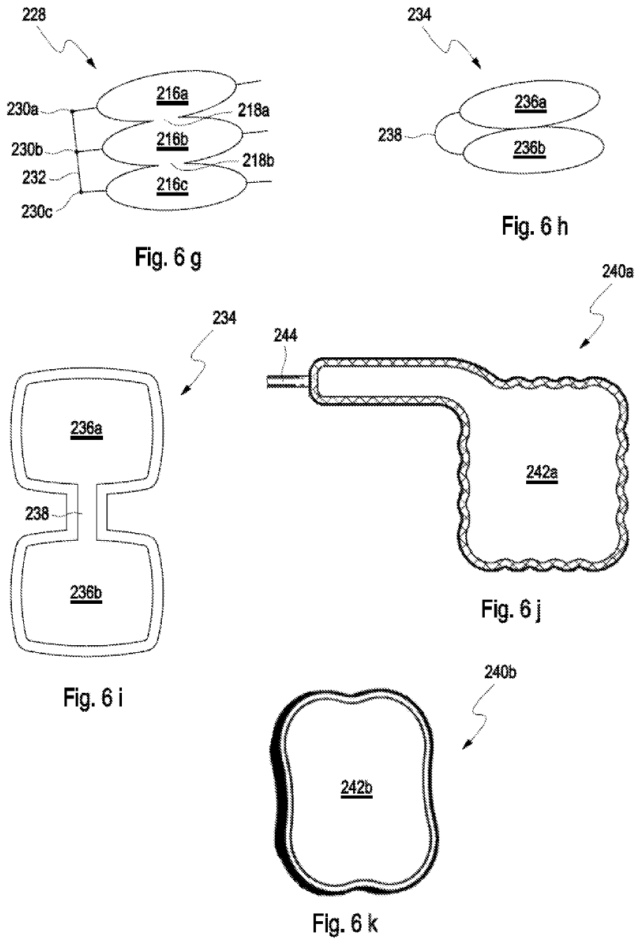

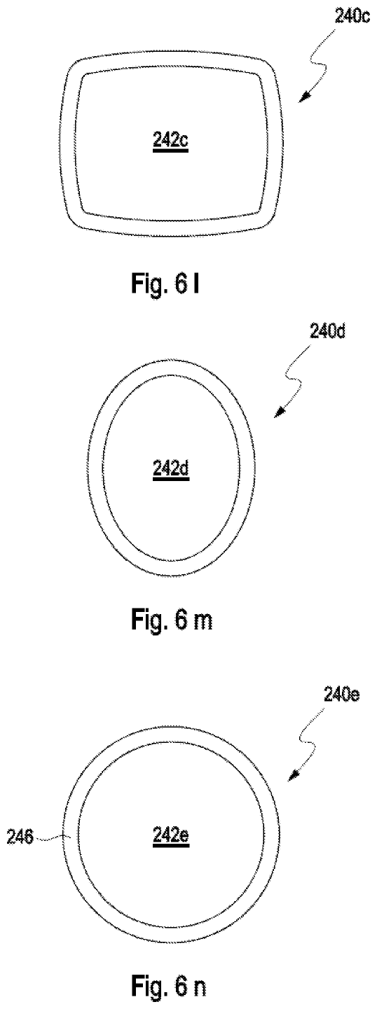

FIG. 6a schematically shows an example of a massage element formed as a massage bubble 200, which has only one pneumatic chamber 202.

A further example of a massage bubble 204 as a massage element is shown from the side in FIG. 6b and from above in FIG. 6c. This massage bubble 204 comprises a first upper chamber 206 and a second lower chamber 208, which are pneumatically connected to one another by an overflow element 210. In addition, FIG. 6c also shows a line 212, via which at least one of the two chambers 206, 208 is supplied with air or supply air, wherein said air can be exchanged between the two chambers 206, 208 via the overflow element 210.

FIG. 6d shows a further example of a massage bubble 214 as a massage element which has a total of three chambers 216a, 216b, 216c arranged over one another in this case, which are connected to one another respectively via an overflow element 218a, 218b.

A further example of a massage bubble 220 as a massage element, which is schematically shown in FIG. 6e, is based on the massage bubble 214 shown in FIG. 6d, wherein, in addition to the three chambers 216a, 216b, 216c arranged over one another and the overflow elements 218a, 218b arranged in between, the massage bubble 220 shown in FIG. 6e has two guides 222a, 222b, which are formed to guide and/or to support the chambers 216a, 216b, 216c arranged in between such that the stroke movement to be executed by the massage bubble 220 is executed along the guides 222a, 222b.

During operation of the massage bubble 204 presented in FIGS. 6b and 6c, one embodiment provides that the lower chamber 208 is filled with air directly which then reaches the upper chamber 206 via the overflow element 210. The overflow element 210 can be characterized and/or formed as an opening between the two chambers 206, 208, via which opening there is an exchange of air between the chambers 206, 208. This example of the massage bubble 204 can be formed or characterized as a double-stroke bubble or two-stroke bubble.

In the embodiment, a respective guide 222a, 222b for the massage bubble 220 can be provided via a foam, a film, and/or a cover of the seat, in which the massage bubble 220 is arranged. An unbowed caving or buckling of the massage bubble 220 can be counteracted by providing the guides 222a, 222b, which in this case is possible using guides 222a, 222b as well as using a central arrangement of the overflow elements 218a, 218b alternatively or additionally.

The massage bubble 224 schematically shown in FIG. 6f as a massage element also has three chambers 216a, 216b, 216c, wherein, however, it is provided here that the overflow elements 226a, 226b are arranged off-center, to the side here, between two chambers 216a, 216b, 216c each, in contrast to the massage bubbles 214, 220 from FIGS. 6d and 6e.

The example of the massage bubble 228 presented in FIG. 6g as a massage element is based on the examples of the massage bubble 214, 220 shown in FIGS. 6d and 6e, wherein it is additionally provided here that each of the three chambers 216a, 216b, 216c is adhered to a film strip 232 via a respective adhesion point 230a, 230b, 230c. FIG. 6h shows a further massage bubble 234 with two chambers 236a, 236b, which are connected to one another in this case via an overflow element 238 arranged laterally or externally, wherein air can be exchanged between the two chambers 236a, 236b via said overflow element 238.

In one implementation of the method with a respective massage bubble 204, 214, 220, 224, 228, 234, the massage bubbles 204, 214, 220 with the chambers 216a, 216b, 216c positioned over one another execute a straight or longitudinal stroke movement during the filling with air.

A straight stroke movement, which is additionally superposed by a rotation, can be executed in the examples of the massage bubbles 224, 228, 234 from FIGS. 6f, 6g, and 6h as massage elements with overflow elements 226a, 226b, 238 arranged off-center or decentrally and/or with the massage bubbles 216a, 216b, 216c adhered to the film strip 232. This rotation is enabled by the off-center overflow elements 226a, 226b, the film strip 232, to which the chambers 216a, 216b, 216c are adhered, and/or the lateral overflow element 238 formed, e.g., as a tube.

FIG. 6i shows the massage bubble 234, which is shown from a lateral perspective in FIG. 6h, in the unfolded state in a plan view.

As FIGS. 6j, 6k, 6l, 6m, and 6n further show, the massage bubbles 240a, 240b, 240c, 240d, 240e respectively shown therein or the active surfaces 242a, 242b, 242c, 242d, 242e thereof have different shapes or contours. In this case, the massage bubble 240a shown schematically in FIG. 6j has an active surface 242a with a basic rectangular shape with rounded corners and several rounded indentations. FIG. 6j further shows also a line 244, through which air is supplied to the massage bubble 240a.

A contour 242b of the massage bubble 240b schematically shown in FIG. 6k has a basic rectangular shape with rounded corners and rounded recesses, as they are also provided, for example, with massage bubble 42b from FIG. 2e and massage bubble 54 from FIG. 5.

An active surface 242c of the massage bubble 240 schematically shown in FIG. 61 has an extensively rectangular contour here, which is cambered on the sides.

A contour 242d of the massage bubble 240d schematically shown in FIG. 6m has an oval contour here.

The massage bubble 240e from FIG. 6n has a round active surface 242e here, which is additionally enclosed by a weld seam 246.

### LIST OF REFERENCE NUMERALS

2 Massage system

4 Seat

6 Headrest

8 Backrest

9a, 9b Side bolster

10 Seat cushion

11 Massage bubble

12a, 12b, Active surface

14a, 14b, Massage bubble

15a, 15b,

16a, 16b,

16c, 16d,

18a, 18b,

20a, 20b,

22a, 22b

24 Plane

30 Massage system

32 Seat

34 Headrest

36 Backrest

38 Plane

40a, 40b, Massage bubble

42a, 42b,

43 Arrow

46 Cavity

48 Pull strap

50 Cover

52 Tube

54 Massage bubble

56 Overflow element

58, 60 Edge

62 Dotted circle

64 Arrow

65 Line

66 Arrow

68 Rod

70 Person

72 Edge

130 Massage system

134 Headrest

138 Plane

142a, 142b, Massage bubble

144a, 144b

146 Cavity

200 Massage bubble

202 Chamber

204 Massage bubble

206, 208 Chamber

210 Overflow element

212 Line

214 Massage bubble

216a Chamber

216b, 216c,

218a, 218b Overflow element

220 Massage bubble

222a, 222b Guide

224 Massage bubble

226a, 226b Overflow element

228 Massage bubble

230a, 230b Adhesion point

230c

232 Film strip

234 Massage bubble

236a, 236b Chamber

238 Overflow element

240a, 240b Massage bubble

240c, 240d,

240e

242a, 242b Active surface

242c, 242d,

242e

244 Line

246 Weld seam

1-10. (canceled)

11. A massage system for a seat, comprising: a seat surface, wherein at least one plane is defined for the seat which plane is spanned by a longitudinal axis and a vertical axis of the seat, wherein the at least one plane respectively separates a first side and a second side of the seat from one another and bisects the seat, wherein at least one massage element is arranged in at least one component of the seat, wherein the at least one massage element has at least one active surface, which is arranged on at least one of the sides of the seat, wherein the at least one active surface of the at least one massage element executes at least one stroke movement which is oriented parallel, downwards, and/or upwards at least partially in the direction of the at least one plane and/or as relates to the seat surface, to have contact with a region of a body of a person sitting in the seat and to implement a massage for said region.

12. The massage system of claim 11, wherein at least one row with massage elements is arranged in the at least one component of the seat, wherein a first part of the massage elements is arranged on the first side and a second part of the massage elements is arranged on the second side of the seat, wherein at least one massage element is designed to execute a stroke movement which is oriented parallel, outwards, downwards, and/or upwards at least partially in the direction of the at least one plane and/or relative to the seat surface.

13. The massage system of claim 11, wherein at least one massage element is formed as a pneumatic massage bubble and/or as an electromechanical massage element.

14. The massage system of claim 11, wherein several active surfaces together form a concave curvature on a surface of the at least one component of the seat.

15. The massage system of claim 11, wherein at least one massage element is arranged in a component of the seat formed as a headrest and/or in a component of the seat formed as a backrest.

16. The massage system of claim 11, further comprising: at least one control unit, which is connected to at least one massage element and controls a stroke movement of the at least one massage element.

17. The massage system of claim 11, wherein at least one massage element is arranged in at least one side bolster as a component of the seat, wherein the at least one side bolster executes a movement which is at least partially oriented in the direction of the at least one plane.

18. A method for massaging a region of a body of a person sitting in a seat having a seat surface, wherein at least one plane is defined for the seat, which plane is spanned by a longitudinal axis and a vertical axis of the seat, wherein the at least one plane respectively separates a first side and a second side of the seat from one another and bisects the seat, wherein at least one massage element is arranged in at least one component of the seat, wherein the at least one massage element has at least one active surface which is arranged on at least one of the sides of the seat, wherein a stroke movement is executed by the at least one active surface of the at least one massage element, which stroke movement is oriented parallel, downwards, and/or upwards at least partially in the direction of the at least one plane and/or relative to the seat surface, wherein the region of the body of the person sitting in the seat is in contact and is massaged with the at least one active surface of the at least one massage element.

19. The method of claim 18, wherein a region of the person formed as the neck, a region of the person formed as the shoulder, and/or a region of the person formed as the lateral torso is massaged.

20. The method of claim 18, wherein air is filled into massage elements, which are formed as pneumatic massage bubbles, wherein the same quantity of air is stored in at least two pneumatic massage bubbles and/or different quantities of air are stored in at least two pneumatic massage bubbles at a point in time.

21. The massage system of claim 12, wherein at least one massage element is formed as a pneumatic massage bubble and/or as an electromechanical massage element.

22. The massage system of claim 12, wherein several active surfaces together form a concave curvature on a surface of the at least one component of the seat.

23. The massage system of claim 13, wherein several active surfaces together form a concave curvature on a surface of the at least one component of the seat.

24. The massage system of claim 12, wherein at least one massage element is arranged in a component of the seat formed as a headrest and/or in a component of the seat formed as a backrest.

25. The massage system of claim 13, wherein at least one massage element is arranged in a component of the seat formed as a headrest and/or in a component of the seat formed as a backrest.

26. The massage system of claim 14, wherein at least one massage element is arranged in a component of the seat formed as a headrest and/or in a component of the seat formed as a backrest.

27. The massage system of claim 12, further comprising: at least one control unit, which is connected to at least one massage element and controls a stroke movement of the at least one massage element.

28. The massage system of claim 13, further comprising: at least one control unit, which is connected to at least one massage element and controls a stroke movement of the at least one massage element.

29. The massage system of claim 14, further comprising: at least one control unit, which is connected to at least one massage element and controls a stroke movement of the at least one massage.

30. The massage system of claim 15, further comprising: at least one control unit, which is connected to at least one massage element and controls a stroke movement of the at least one massage element.
